(19) United States
(12) Patent Application Publication
(10) Pub. No.: US 2007/0267560 A1
(43) Pub. Date: Nov. 22, 2007

(54) Play slide footer

(75) Inventor: Jeffrey S. Robertson, White, GA (US)

Correspondence Address: TROUTMAN SANDERS LLP, 600 PEACHTREE STREET , NE, ATLANTA, GA, 30308, US

(73) Assignee: PLAYNATION PLAY SYSTEMS INC., Marietta, GA (US)

(21) Appl. No.: 11/361,851

(22) Filed: Feb. 23, 2006

Related U.S. Application Data
(60) Provisional application No. 60/655,350, filed on Feb. 23, 2005.

(51) Int. Cl. F16M 13/04

(52) U.S. Cl. 248/560

(57) ABSTRACT

An improved play slide footer is disclosed. The play slide footer maximizes the safety and stability, while minimizing the amount of wobble of the slide.

### CROSS-REFERENCE TO RELATED APPLICATIONS

This application claims the benefit of U.S. Provisional Application No. 60/655,350, filed 23 Feb. 2005.

### FIELD OF THE INVENTION

The present invention is related generally to playground equipment and, more particularly, to a playground play slide footer providing stationary footing with advanced safety features.

### BACKGROUND OF THE INVENTION

Playgrounds can be found in nearly every city. Although the equipment varies considerably among playgrounds, a common objective of all playground equipment is to provide a safe and entertaining atmosphere for children of all ages.

One type of playground equipment found on most playgrounds is the slide. Slides are commonly made of plastic, wood, metal, and other materials both being durable to withstand years of weathering, but also with a relatively low coefficient of friction for ease of sliding. Usually, slides are bounded by side walls to keep the slider from falling off. Slides can also have a footer at the bottom, to aid in the stability of the slide by reinforcing the bottom of the slide, whereby limiting the slide's overall movement.

Residential slides can be molded out of plastic material, such as polyethylene or similar material. In addition to the common straight downward slide, plastic provides a designer with the safety and flexibility to design slides with angles (e.g., spiral or 90° slides) and tubes, which can cover the entire slide. Fortunately, the addition of plastic-type slides allows users to twist around while riding down a slide, enhancing the user's playground experience.

Conventional metal slides were simply straight in design. The play slides were a metal or wood structure providing a straight, downward slide. Metal and wood designs were much more limited than today's plastic models. For instance, U.S. Pat. No. 3,273,877 to Grudoski discloses a play slide having an inclined sheet metal slide bed, rigidly held between two tubular D-rails. The bottom end of the metal slide bed is supported by a foot support, which is inserted into the open ends of the D-rails and by an anchor stake which can be driven through the support. One disadvantage to this type of design is that the terminus of the slide bed is distant the ground; thus, the slide is prone to wobbling and instability during use.

Plastic slides are now common. These provide safe and flexible slides that can be designed at various angles, shapes, and sizes. Unfortunately, plastic slides also often end a distance from the ground. For instance, U.S. Pat. No. 4,487,411 to Ahrens discloses a slide bed, wherein the second end of the slide bed—that below the first end and the terminus of the slide from the top to the bottom—is positioned distant from the ground. Designs that have a terminus distant the ground can foster excessive wobbling of the slide bed, thus compromising stability of the slide, as they typically include only support posts planted into the ground.

In view of the above disadvantages with the current merchandising of play sets, it would be beneficial if play slides could be promoted to the public in a safe, economical way by using an improved play slide footer, maintaining stability in the slide. It is to such a device that the present invention is primarily directed.

### SUMMARY OF THE INVENTION

Briefly described, in a preferred form, the present invention is an improvement over the conventional play slide footers by providing a solid support design to maximize stability and minimize wobbling upon use of the slide. The play slide footer can interlock with existing slides to provide the maximum stability and safety in a playground environment.

In a preferred embodiment, the play slide footer of the present invention is for a slide of playground equipment, the slide having a slide bed, the footer comprising a pair of opposing side walls forming a footer slide bed therebetween, the footer slide bed presenting a concave shape, a first end of the footer the first end of the footer cooperatively shaped to provide a seamless transition from the slide bed of the slide to the footer slide bed when the footer is connected to the slide, a second end of the footer, the second end of the footer providing exit from the footer, and a footer stability system providing stability to the footer, the footer stability system including a first stability member extending from the proximity of the first end of the footer, and angled substantially downwardly towards the ground, and a second stability member extending from the proximity of the second end of the footer, and angled substantially parallel to the ground, the first and second stability members connected to one another, and providing stability to the footer.

The first and second stability members can be arranged to form an angle therebetween in the range of 70°-90°, and so arranged to minimize open crawl space beneath the footer, limiting the possibility of a child crawling beneath the footer.

The footer stability system of the present invention can further comprise a third stability member directly connecting the footer to the playground apparatus, and/or a fourth stability member being a ground portion of the footer, directly embedded into the ground.

The third stability member can be a strap extending from the first end of the footer to the playground apparatus, and the fourth stability member can be a stake extending from the second end of the footer into the ground.

The play slide footer can include a plurality of ribs extending along an exterior of at least one of the opposing side walls of the footer.

These and other objects, features, and advantages of the present invention will become more apparent upon reading the following specification in conjunction with the accompanying drawings.

### BRIEF DESCRIPTION OF THE DRAWINGS

FIG. 1 is a perspective view of a play slide with a preferred embodiment of a play slide footer according to the present invention.

FIG. 2 is a perspective view of the preferred embodiment of a play slide footer of FIG. 1.

FIG. 3 is another perspective view of the play slide with a play slide footer of FIG. 1.

FIG. 4 is a top perspective view of a preferred embodiment of installation hardware for a footer of the present invention.

### DETAILED DESCRIPTION OF PREFERRED EMBODIMENTS

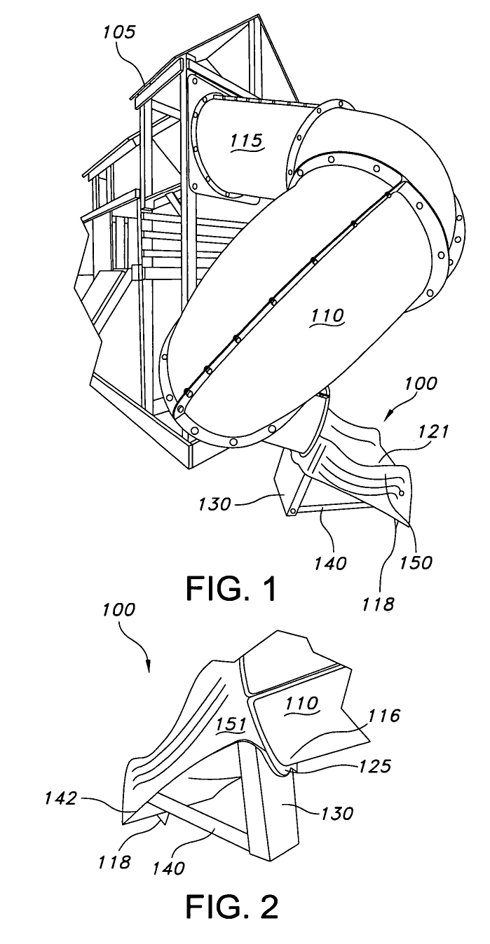

Referring now in detail to the figures, FIG. 1 illustrates a preferred embodiment of a play slide footer 100 attached to a playground apparatus 105 having a tube slide 110. The play slide footer 100 and the tube slide 110 can be preferably molded of plastic material, such as polyethylene, some similar material using a rotational molding process, or other suitable processes for molding plastic. Both the slide 110 and the footer 100 can be made in a variety of colors and shapes.

Indeed, the play slide footer 100 and the slide 110 can also be constructed from other polymer materials, such as polyolefins, such as, but not limited to ultra-high molecular weight (UHMW) polyethylenes, low, medium, and high density polyethylenes, polyurethanes, polyamides, and copolymers, and combinations thereof. In addition, other materials, including metals such as aluminum, titanium, and the like, metal alloys, ceramics, and the like, can be used for the footer 100 and the slide 110, without departing from the scope of the invention. The material selected for the footer 100 and the slide 110 is, preferably, weatherproof.

The slide 110 has a first upper end 115 and a second lower end 116, between which ends 115, 116 runs a slide bed 120. The first end 115 is attachable to a playground apparatus 105 allowing the user to be elevated at the beginning of the slide 110. Alternately, the first end 115 can be attached to the zenith, or peak, of a ladder (not shown) for entry onto the slide bed 120 of the slide 110. The second end 116 is at the terminus of the slide bed 120, which is preferably in proximity with the ground. The play slide footer 100 is preferably relatively seamlessly attached to the second end 116 of the slide 110.

With the slide 110 connected to the play slide footer 100, the slide bed 120 continues seamlessly from the slide 110 to the play slide footer 100 to flow into slide bed 121 of the footer 100. The slide bed 121 can be wider than the slide bed 120 to better control the rider, and create a better landing experience.

FIG. 2 is a perspective view of a side of the footer 100. The play slide footer 100 is attached to the slide 110, mating with the second end 116 of the slide 110. The second end 116 and the footer 100 can be bolted and/or welded together at an engagement area 125. The footer 100 has a footer stability system providing stability to the footer 100, the footer stability system including a first stability member, or brace, 130 extending from the proximity of a first end 117 of the footer, and angled substantially downwardly towards the ground, and a second stability member, or brace, 140 extending from the proximity of a second end of the footer, and angled substantially parallel to the ground, wherein the first and second stability members 130, 140 are connected to one another generally at a location under the second end 116 of the footer 100. The stability member 130 can be substantially the same width as the footer 100, which provides additional stability. The second stability member 140 can be connected to the second end of the footer, at, for example, a location 142, which can be a bolt location 142.

Alternatively, first and second braces 130, 140 can be of unitary construction. Collectively, the first stability member 130 and the second stability member 140 can form an angle of less than 90°, for example, in a range of 70°-90°, and more preferably in a range of 80°-90°, aiding in structural integrity and providing increased stability of the footer 100. In a most preferred embodiment, the first stability member 130 and the second stability member 140 form a 90° angle. Additionally, the connected braces 130, 140 can minimize crawl space beneath the footer 100, helping limit, if not eliminate, the possibility of children crawling beneath the footer 100, and/or injuring themselves or users sliding down the slide bed 120 of the slide 110.

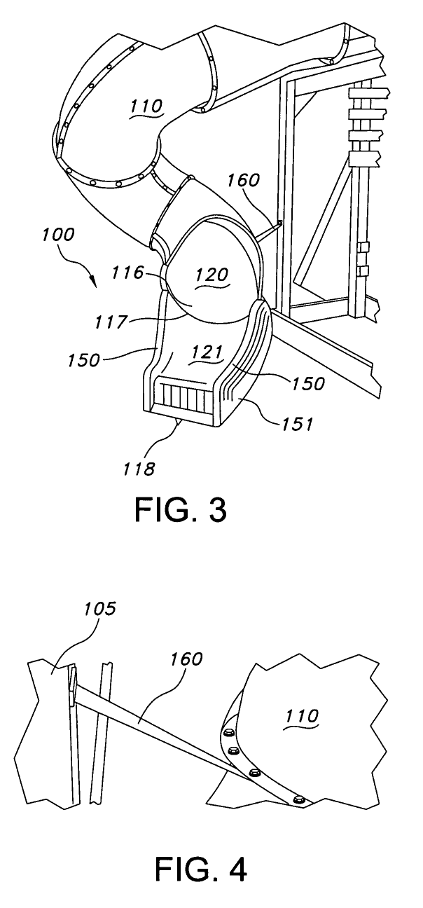

FIG. 3 is another perspective view of the footer 100 connected to the tube slide 110. The view of this figure illustrates the footer 100 by showing connection of the slide bed 120 of the footer 100 and the tube slide 110. Hence, the seamless transition from the slide bed 120 of the slide 110 to the slide bed 121 of the footer 100 is illustrated.

Preferably, the footer slide bed 121 has a concave shape enabling the transition from the slide bed 120 of the slide, and to conform to the shape of a rider's backside. Indeed, in another embodiment, the shape of the footer slide bed 121 can be U-shaped.

The footer 100 can have side walls 150 on opposing sides of the footer slide bed 121. The slide walls 150 preferably provide a smooth transition to the slide bed 120 of the footer 100. The slide wall 150 can include a number of preformed, integrated molded ribs 151 that run along the length of an exterior of the side walls 150 of the footer 100. The ribs 151 can further provide added stability and structural strength to the footer 100.

The play slide footer 100 has a first end 117 and a second end. The first end 117 is cooperatively shaped to provide the smooth transition from slide bed 120 of the slide to the slide bed 121 of the footer 100. In a preferred embodiment, the connection of the slide bed 120 of the slide 110 and the footer slide bed 121 is approximately fifteen inches off the soil or ground.

In a preferred embodiment, the second end of the footer is a straight drop, or perpendicular to the ground. This angle, or drop, is recognized as the best to allow users to stand and leave the slide 100 easily. One skilled in the art can appreciate that the angle between the ground and the second end can be other angles. In a particular embodiment, the drop of the second end is approximately ten inches in length.

In a preferred embodiment the dimensions of the footer 100 are twenty-seven inches in length by twenty-eight inches in width by eleven inches in height (27″ l×28″ w×11″ h). Again, one skilled in the art will appreciate that the size of the footer 110 can vary based on the connection to the slide 110.

FIG. 4 illustrates connectability of the footer 100 to the playground apparatus 105 for added stability. The footer stability system can further comprise a third stability member 160 to connect the footer 100 to the apparatus 105 for additional support. In a preferred embodiment, the third stability member is a strap that enhances the lateral stability of the footer 100. In a preferred embodiment, the strap member 160 can be made of poly webbing. One skilled in the art will appreciate that the material of the strap member 160 can be of many like materials that provide additional support for the footer 100. The strap member 160 can be bolted to the apparatus 105 and to the footer 100. In addition, there can be equalized bolt holes in the strap member 160 to make installation easier. Thus, there is no need for a wood frame for the footer 100.

The inventive footer 100 provides additional reinforcement for the stability of the slide 110, preferably by having a fourth stability member of the footer stability system, the fourth stability member being a portion of the footer embedded into the soil or the ground. This can be accomplished by a stake or metal rod 118 located in proximity to the second end of the footer being inserted into the soil, ground, concrete footing, and the like. The footer 100 minimizes slide wobble and provides stability upon exiting the slide 110.

A user riding the slide 110 will glide downward from the first end 115 to the second end 116 of the slide 110. Then, upon passing the second end 116 of the slide 110, the user will continue to glide onto the slide bed 121 of the footer 100, from the first end 117 to the second end 118 of the footer 100. The user's legs can then make contact with the ground. With the side walls 150 of the footer 100, the user can lift his/her self up and stand to make another trip up and down the slide 110 onto the footer 100.

To facilitate an understanding of the principles and features of the invention, it is explained hereinabove with reference to its implementation in an illustrative embodiment. In particular, the invention is described in the context of being a footer for a play slide. The invention, however, is not limited to its use as a footer for a play slide. Rather, the invention can be used when support is necessary. Thus, the footer described hereinafter as a play slide footer can also find utility as a footer for other applications.

Additionally, the material described hereinabove as making up the various elements of the footer of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

While the invention has been disclosed in its preferred forms, it will be apparent to those skilled in the art that many modifications, additions, and deletions can be made therein without departing from the spirit and scope of the invention and its equivalents, as set forth in the following claims.

What is claimed is:

1. A play slide footer for a slide of playground equipment, the slide having a slide bed, the footer comprising:
a pair of opposing side walls forming a footer slide bed therebetween, the footer slide bed presenting a concave shape;
a first end of the footer the first end of the footer cooperatively shaped to provide a seamless transition from the slide bed of the slide to the footer slide bed when the footer is connected to the slide;
a second end of the footer, the second end of the footer providing exit from the footer; and
a footer stability system providing stability to the footer, the footer stability system including a first stability member extending from the proximity of the first end of the footer, and angled substantially downwardly towards the ground, and a second stability member extending from the proximity of the second end of the footer, and angled substantially parallel to the ground, the first and second stability members connected to one another, and providing stability to the footer.

2. The play slide footer of claim 1, the footer stability system further comprising a third stability member directly connecting the footer to the playground apparatus.

3. The play slide footer of claim 1, the footer stability system further comprising a fourth stability member being a ground portion of the footer, directly embedded into the ground.

4. The play slide footer of claim 2, the third stability member being a strap extending from the first end of the footer to the playground apparatus.

5. The play slide footer of claim 3, the fourth stability member being a stake extending from the second end of the footer into the ground.

6. The play slide footer of claim 1, the footer further comprising a plurality of ribs extending along an exterior of at least one of the opposing side walls of the footer.

7. The play slide footer of claim 1, the first and second stability members forming an angle therebetween in the range of 70°-90°.

8. The play slide footer of claim 7, the first and second stability members being arranged to minimize open crawl space beneath the footer, limiting the possibility of a child crawling beneath the footer.

9. A play slide footer for a slide of playground equipment, the slide having a slide bed, the footer comprising:
a pair of opposing side walls forming a footer slide bed therebetween, the footer slide bed presenting a concave shape;
a first end of the footer the first end of the footer cooperatively shaped to provide a seamless transition from the slide bed of the slide to the footer slide bed when the footer is connected to the slide;
a second end of the footer, the second end of the footer providing exit from the footer; and
a footer stability system providing stability to the footer, the footer stability system including a first stability member extending from the proximity of the first end of the footer, and angled substantially downwardly towards the ground, a second stability member extending from the proximity of the second end of the footer, and angled substantially parallel to the ground, the first and second stability members connected to one another, and providing stability to the footer, a third stability member directly connecting the footer to the playground apparatus, and a fourth stability member being a ground portion of the footer, directly embedded into the ground.
